(19) United States
(12) Patent Application Publication
(10) Pub. No.: US 2006/0150321 A1
(43) Pub. Date: Jul. 13, 2006

(54) Portable lifting systems and methods for assistance in standing

(76) Inventors: Kevin Dale Brockman, Union, KY (US); Chad Andrew Calo, Ft. Wright, KY (US); Curtis Maxwell Sheldon, Villa Hills, KY (US); Maximilian Gabriel Tagher, Walton, KY (US); Kevin Allen Topmiller, Ft. Wright, KY (US)

Correspondence Address: DINSMORE & SHOHL, LLP, 1900 CHEMED CENTER, 255 EAST FIFTH STREET, CINCINNATI, OH, 45202, US

(21) Appl. No.: 11/196,669

(22) Filed: Aug. 3, 2005

Related U.S. Application Data
(60) Provisional application No. 60/642,015, filed on Jan. 7, 2005.

(51) Int. Cl. A61G 7/10

(52) U.S. Cl. 5/81.1 R

(57) ABSTRACT

A portable, lightweight device is provided that permits a person to be lifted from a sitting position without the assistance of another person. This device comprises an inflatable bladder and a means of forcing a gas into the bladder. When the person wishes to be lifted from a sitting position, the person merely inflates the bladder, which is positioned appropriately. The inflating bladder then lifts the person to a standing or partially standing position in a safe and controlled manner.

### CROSS REFERENCE TO RELATED APPLICATION

This application claims the benefit of U.S. Provisional Application No. 60/642,015, filed Jan. 7, 2005, the entire disclosure of which is hereby incorporated herein by reference.

### TECHNICAL FIELD

The present invention relates generally to devices for assistance with physical handicaps, and, more particularly, to a portable lifting device for assistance in standing.

### BACKGROUND OF THE INVENTION

Persons with physical handicaps, ailments, or disabilities frequently have difficulty in transitioning from a seated to a standing position. While some inflatable devices have been available for assistance with standing, such devices can have significant disadvantages. For example, while some inflatable seat lifts have been disclosed, often such devices are not intended for ease of portability and require large stationary compressors and other components. In addition, many such devices are intended to be fixed to a single chair and are not configured to be attached and worn by the user.

Moreover, for many such devices, the shape of the seat is fixed, thus only operate on certain types of chairs or seating surfaces. In others, the shape of the inflatable bag limits the variety of chairs or seats in which it can function properly. Still other such devices require the user to expend a significant amount of energy to inflate the device.

### SUMMARY OF THE INVENTION

Accordingly, it is desired to provide improvements in devices for assistance in standing. In particular, in at least some embodiments, it is desired to provide a system and method that overcomes the aforementioned limitations and permits the user to enjoy a portable, lightweight lifting device that is easily transported and operated without the assistance of another person.

Other aspects are also disclosed and covered herein, and still other aspects of the present invention will become apparent to those skilled in the art from the following description wherein there are shown and described illustrative embodiments including inventive aspects. These embodiments and descriptions are provided only as illustrative examples, and in no way are intended, nor should they be interpreted, as limiting. Accordingly, the drawings and descriptions should be regarded as illustrative and exemplary in nature only, and not as restrictive.

### BRIEF DESCRIPTION OF THE DRAWINGS

While the specification concludes with claims particularly pointing out and distinctly claiming the inventive aspects, it is believed the same will be better understood from the following description taken in conjunction with the accompanying drawings in which:

FIGS. 1 and 2 show an illustrative embodiment, made and operating in accordance with principles of the invention;

FIG. 3 shows the illustrative embodiment of FIGS. 1-2, without the user;

FIG. 4 shows a detail of a control circuit 2 that can be utilized with the embodiments disclosed herein and that is also made and operating according to principles of the invention;

FIG. 5 shows one possible construction of an inflatable bladder 1 that can be used in embodiments of the present invention;

FIG. 6 shows alternative components that can be included in the control circuit, according to additional embodiments of the invention; and

FIG. 7 shows an alternative embodiment where the device is integrated with the clothing of the user.

### DETAILED DESCRIPTION OF ILLUSTRATIVE EMBODIMENTS

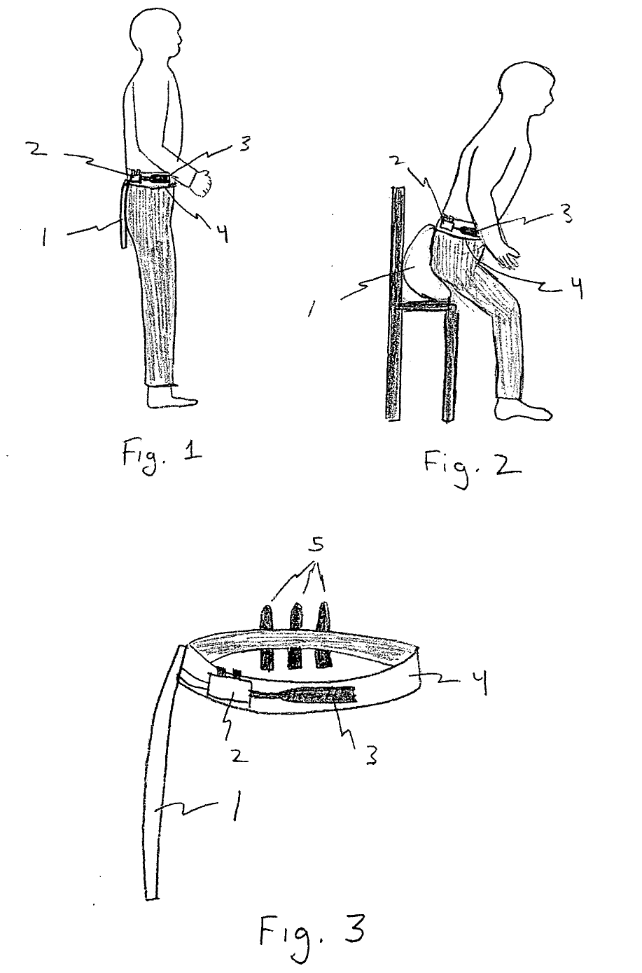

FIGS. 1 and 2 show an illustrative embodiment of the invention. In this embodiment, the inflatable bladder 1 is attached to a belt 4, which is worn by the user. The control circuit 2 and the cylinder with compressed gas 3 are also attached to the belt. FIG. 1 shows the user in a standing position, and FIG. 2 shows the user while changing from a sitting to a standing position.

FIG. 3 shows an illustrative embodiment of the invention without the user. As before, in this embodiment, the inflatable bladder 1, control circuit 2, and cylinder with compressed gas 3 are all attached to the belt 4. In this figure, spare cylinders with compressed gas 5 are also attached to the belt.

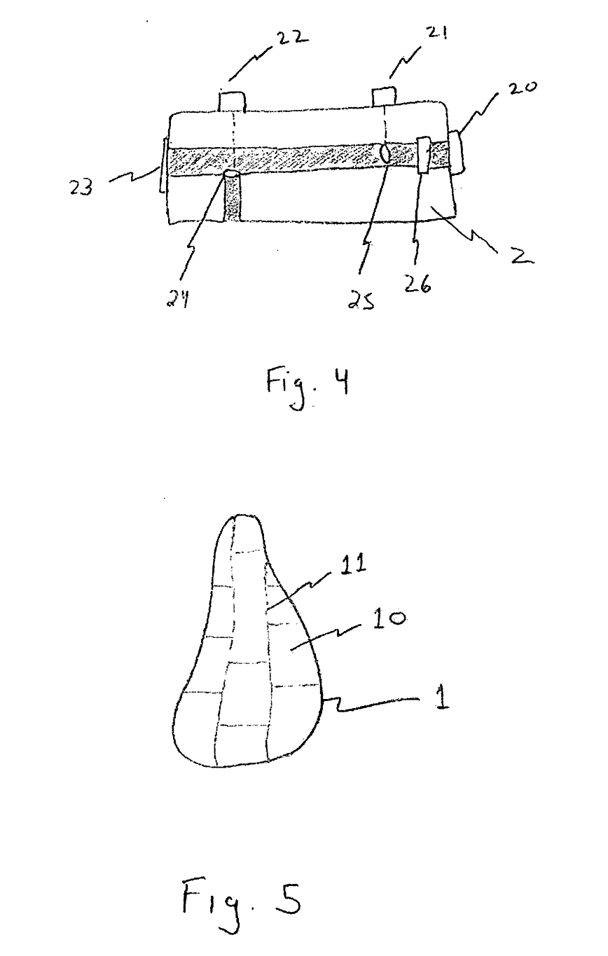

FIG. 4 shows a detail of the control circuit 2. In this embodiment, the cylinder is attached to a quick-disconnect pneumatic fitting 20. The “Inflate” pushbutton 21 is attached to a valve 25 which enables the compressed gas to be directed to the bladder. A pressure regulator 26 may be used to decrease the inflation rate and for safety. A “Deflate” pushbutton 22 is attached to a valve 24 which enables the gas in the bladder to be directed to the atmosphere, thus causing the bladder to deflate. And finally, a pneumatic connection 23 to the bladder is provided.

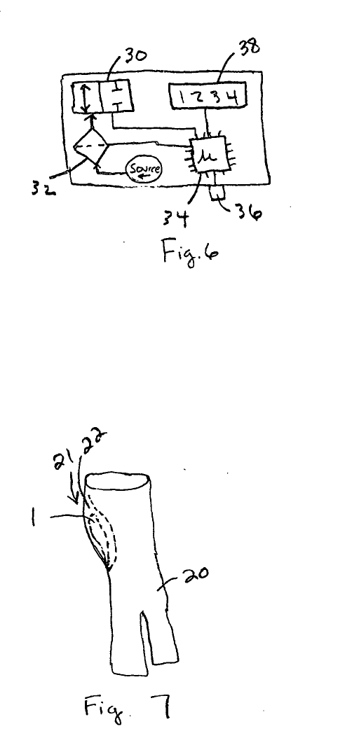

FIG. 5 shows one possible construction of the inflatable bladder 1. Internally, the bladder may be divided into a plurality of discrete chambers 10 by walls 11. This type of construction will define the shape of the bladder when fully or partially inflated. The walls 11 that form the chambers may also create an internal force within the bladder that speed up the deflation of the bladder.

More specifically, the illustrative embodiment of FIGS. 1-5 comprises an inflatable bladder 1, a control circuit 2, a source of compressed gas 3, and a means to attach all components to the user, such as a belt 4. Other embodiments of this invention may be used without deviating from the spirit of this invention.

The inflatable bladder 1 is comprised of any natural or man-made material that is impervious to the gas used. The shape of the bladder can take many forms, including but not limited to triangular and toroidal. This shape may depend on the size of the person for whom it is to be used. Also, the shape may be customized so as to minimize the stress or pain of an injured area, such as the spine.

Furthermore, the bladder 1 may internally be sub-divided into a plurality of chambers 10. These chambers 10 may be inflated in a certain sequence so as to facilitate the raising of the user. Also, the bladder 1 may be constructed so that one part of it inflates more than another part of it. This could allow the back portion of the bladder to inflate more than the front part of it, which would facilitate the lifting of the user. Furthermore, the bladder 1 may consists of a number of smaller bladders which are attached so as to appear and function as one larger bladder.

And finally, the bladder 1 may be worn by the user. It may be attached to the waist of the user via a belt 4 or other attachment. And, if necessary, the bladder 1 may be additionally attached to the legs. This allows the user to freely move about without having to physically carry the bladder. When worn by the user in such a fashion, the device is intended to maximize its mobility and minimize its awareness by the user. However, in some instances, the user may choose not to wear this device accordingly. In this case, the user may wish to carry the bladder discretely. But, because the bladder 1 can be constructed of lightweight materials, the ease of portability is maintained. FIG. 7 shows an embodiment wherein the bladder 1 is worn by the user by integrally attaching the bladder to the user's clothing. For example, the bladder 1 could be attached to or held within the seat portion 21 of a pair of pants 20, such as within a pocket 22 of the pants.

Another aspect of the invention comprises the control circuit 2, as best shown in FIG. 4, which controls the flow of the gas into or out of the bladder 1. The control circuit 2 may also limit the amount of gas pressure into the bladder or may control the rate of inflation. The control circuit 2 would also allow easy changing of the source of compressed gas, for example, by using a quick-disconnect pneumatic fitting 20. Furthermore, the control circuit 2 may consist of one or more pneumatic valves 30, a pressure regulator 32, a number of electric or pneumatic pushbuttons 36, and/or an electronic monitoring circuit 34. The electronic monitoring circuit, if used, may consist of discrete electronic components, including but not limited to a microprocessor, which will perform the desired control function. Moreover, this electronic monitoring circuit can provide a safe mode of operation in the event of a malfunction, such as may be caused by abnormally high or low cylinder pressures. And the electronic monitoring circuit may provide visual indication of operating conditions; for example, it may indicate via an electronic display 38 how much air pressure is remaining in the cylinder.

The control circuit 2 can be physically combined with the bladder 1 or the source of compressed gas without deviating from the spirit of the invention.

According to another aspect, a source of compressed gas 3 is provided. This can assume a number of different forms: an electric air compressor, a manual air compressor, or a cylinder containing compressed gas. In an illustrative embodiment, the cylinder containing compressed gas is used.

According to some aspects of the present invention, a compressed gas cylinder 3, such as used for toy guns and the like, can be used as a power source to inflate the bladder 1. Such a cylinder can provide a lightweight and inexpensive inflation source.

The amount of compressed gas in the cylinder depends on a number of well-known factors, such as the volume of the cylinder and its maximum pressure rating. Any number of various types and/or sizes of cylinders may be used. The construction of the cylinder can assume many types, including but not limited to aluminum and composite materials. The size of the cylinder may also vary, but in order to provide most portable, the user should be able to carry several of these, without too much difficulty, as spare cylinders 5.

Also, any container that is capable of storing compressed gas may be used, and not just a “cylinder.” Such a container may take any shape, such as a sphere.

Other sources of compressed gas may be used, as well, although these may limit portability. Sources such as an electric compressor or manual compressor may also be used without deviating from the spirit of the invention, and these can be powered by a portable power source, such as batteries and the like. Alternatively, a cord may be provided to hook into power from an outlet.

A compressed gas may also be produced by the chemical reaction of combining two or more substances, hereafter called reagents. For example, a well-known chemical reaction is the combination of the liquid acetic acid (vinegar or CH₃COOH) and the solid sodium bicarbonate (baking soda or NaHCO₃). This reaction produces three new substances: the solid sodium acetate (NaCH₃CO₂), the liquid water (H₂O), and the gas carbon dioxide (CO₂). One of the results of this reaction is that the end products have a significantly larger volume than the original reagents. In this fashion, a source of compressed gas is the potential energy of such reagents before their combination. In lieu of a cylinder of compressed gas, the user may carry an appropriate amount of these reagents, each of which may a solid, liquid, or gas. If any of the reagents are a gas, it may or may not be compressed. Naturally, such reagents should be inexpensive, lightweight, safe, and readily available. In order to inflate the bladder, the user presses the “Inflate” button as before. However, the compressed gas is produced by the aforementioned chemical reaction, which is managed automatically by the control circuit.

In an illustrative embodiment, the user attaches all major components to himself via a belt 4 around his waist and/or two smaller belts around his thighs. This permits the maximum portability for and minimum discomfort to the user. The control circuit 2 may be physically included in either bladder 1 or the cylinder with compressed gas 3 so as to minimize the overall weight and size.

The bladder 1 is initially deflated, and does not cause any discomfort to the user. Also, the bladder 1 does not limit the range of motion of the user or type of activities the user may perform. If the user wishes to remove the bladder 1, in order to changes clothes or use the restroom, for example, he may do so relatively easily.

The control circuit 2 can be built into the bladder. In this embodiment, there are two buttons 21 and 22 on the control circuit 2: one will inflate the bladder, the other one will deflate it. There is a connection 20 on the bladder for the compressed gas cylinder 3. There is also a method to attach the cylinder to the bladder so it does not easily fall off.

When using this embodiment, the user wears the bladder 1 with the control circuit 2 and cylinder 3 attached. When the user sits down, the bladder 1 is either already deflated or deflates as he sits. When the user wants to stand, he presses the “Inflate” button 21 on the bladder, and the bladder 1 begins to inflate, using the compressed gas in the cylinder 3 to fill the bladder 1. After the user is able to stand, he presses the “Deflate” button 22 on the control circuit 2. This stops the inflation process and vents the gas inside the bladder 1 to the atmosphere, thus causing the bladder 1 to deflate. Additionally, the bladder 1 may contain an apparatus, such as a spring, that causes it to return to its deflated state more rapidly.

Once the user is standing, he may also need other equipment in order to help him move about, such as a walker. Accordingly, this embodiment of the invention provides a lightweight, portable method of assisting a person from a sitting to standing position without the help of another person.

This inventive embodiment can be used in a number of locales and situations, such as restaurants, sports stadiums, theaters, and places of employment. It can benefit many different types of people, including men, women, old people, young people, people with sports injuries, and people with limited use of their legs. The device is very portable and easily used. The power source is inexpensive and widely available.

What is claimed is:

1. A portable device for assistance in raising a person from a seated position to a standing position, the device comprising:
a source of compressed gas;
a first valve configured to control the release of the compressed gas from the source;
a bladder in fluid communication with the source of compressed gas and configured to receive compressed gas therefrom, wherein the bladder is sized and configured to substantially cover from approximately the upper rear leg area of the user to approximately the rear waist area of the user;
a second valve configured to control the release of the compressed gas from the bladder to the atmosphere;
a control circuit configured to control the first and second valves to provide for inflation and deflation of the bladder;
a belt configured to attach directly or indirectly to the source, valve, and bladder and to allow the bladder to be positioned behind the user and extend from the waist to the upper leg portions; and
at least one switch configured to control the control circuit and to control the inflation and deflation of the bladder.

2. The device as recited in claim 1, wherein the bladder has a volume configured to raise the user a distance in a range of from about 2 inches to about 24 inches.

3. A portable device for assistance in raising a person from a seated position to a standing position, the device comprising:
a source configured to provide a gas;
a bladder in fluid communication with the source of compressed gas and sized and configured to be located beneath the seat region of a person when in a sitting position;
a control device configured to control the supply of gas to provide for inflation of the bladder;
at least one attachment device configured to attach directly or indirectly to the source and bladder to allow the source and bladder to be carried by the user.

4. The device as recited in claim 3, wherein the bladder has a volume configured to raise the user a distance in a range of from about 2 inches to about 24 inches.

5. The device as recited in claim 3, wherein the source includes reagents configured to selectively react with one another to produce the gas.

6. The device as recited in claim 3, wherein the control device includes a control circuit having a microprocessor.

7. The device as recited in claim 3, wherein the attachment device comprises a belt configured to be worn around the waist of the user such that the bladder is positioned behind the user and below the waist while the user is standing.

8. The device as recited in claim 3, wherein the bladder is attached inside an item of clothing.

9. The device as recited in claim 8, wherein the item of clothing comprises pants or shorts.

10. The device as recited in claim 9, wherein the at least one attachment device comprises threads holding the bladder within the item of clothing.

11. The device as recited in claim 3, further comprising an electronic display.

12. The device as recited in claim 3, further comprising a pressure regulator.

13. The device as recited in claim 3, wherein the control device comprises a button.

14. The device as recited in claim 3, wherein the bladder comprises a plurality of connected smaller bladders.

15. A method for providing lifting assistance in standing, the method comprising:
wearing an inflatable member such that it is carried by the body;
sitting such that the inflatable member is positioned between the seating surface and a region of the body contacting the seating surface;
inflating the inflatable member by using a control device;
rising from the seating surface by the expansion provided by the inflation of the inflatable member beneath the body;
standing from the seating surface upon inflation of inflatable member; and
deflating the inflatable member.

16. The method as recited in claim 15, wherein the inflatable member comprises a bladder, and wherein the control device comprises a control button.
